(19) United States
(12) Patent Application Publication
(10) Pub. No.: US 2025/0293434 A1
(43) Pub. Date: Sep. 18, 2025

(54) Electronic Device Antennas with Distributed Capacitances

(71) Applicant: Apple Inc., Cupertino, CA (US)

(72) Inventors: Yuechen Yang, San Jose, CA (US); Alexandrine Obrand, Palo Alto, CA (US); Abhay Shankar Anand, Santa Clara, CA (US); Panagiotis Theofanopoulos, Cupertino, CA (US); David Garrido Lopez, San Jose, CA (US); Xiangyu Wang, Santa Clara, CA (US); Kourosh Khanjani, Los Gatos, CA (US); Jordi A. Sim, San Mateo, CA (US); Matthew Derry, Mountain View, CA (US); Subramanian Ramalingam, San Jose, CA (US); Jacob T. Ramirez, Cupertino, CA (US); Forhad Hasnat, Milpitas, CA (US); Ross M. Errett, San Jose, CA (US); Zhe Zhang, Santa Clara, CA (US); Joseph J Sunde, Monterey, CA (US)

(21) Appl. No.: 18/805,444

(22) Filed: Aug. 14, 2024

Related U.S. Application Data
(60) Provisional application No. 63/565,510, filed on Mar. 14, 2024.

(51) Int. Cl. H01Q 13/10; H01Q 5/378

(52) U.S. Cl. CPC H01Q 13/10; H01Q 5/378

(57) ABSTRACT

An electronic device may be provided with peripheral conductive housing structures and a rear wall. An antenna may be formed from a segment of the peripheral conductive housing structures that is separated from the rear wall by a slot. One or more distributed capacitors may be used to tune the response of the antenna. The distributed capacitors may be formed between the segment and a parasitic arm shorted to the rear wall, between a protrusion on the segment and the rear wall, and/or a between conductive traces on a flex coupled to a feed of the antenna. The parasitic arm may be formed from conductive traces on a flexible printed circuit, sheet metal, or other conductive material. The protrusion may extend into the slot and may be embedded in dielectric material. The protrusion may include holes that draw in some of the dielectric material to minimize cosmetic defects.

This application claims the benefit of U.S. Provisional Patent Application No. 63/565,510, filed Mar. 14, 2024, which is hereby incorporated by reference herein in its entirety.

### FIELD

This relates generally to electronic devices, including electronic devices with wireless communications capabilities.

### BACKGROUND

Electronic devices such as portable computers and cellular telephones are often provided with wireless communications capabilities and displays. To satisfy consumer demand for small form factor wireless devices, manufacturers are continually striving to implement wireless communications circuitry such as antenna components using compact structures. At the same time, there is a desire for wireless devices to cover a growing number of communications bands. In addition, to optimize user experience, it is often desirable for the viewing area of a display in an electronic device to be as large as possible.

Because antennas have the potential to interfere with each other and with components in a wireless device such as displays, care must be taken when incorporating antennas into an electronic device. Moreover, care must be taken to ensure that the antennas and wireless circuitry in a device are able to exhibit satisfactory performance over a range of operating frequencies and with satisfactory efficiency bandwidth while still allowing the device to exhibit a compact form factor.

### SUMMARY

An electronic device may be provided with wireless circuitry and a housing. The housing may include peripheral conductive housing structures and a rear housing wall. The electronic device may include a display mounted to the peripheral conductive housing structures opposite the rear housing wall. The rear housing wall may include a conductive plate. The conductive plate may be separated from a segment of the peripheral conductive housing structures by a slot.

The electronic device may have an antenna that radiates through the rear housing wall and/or the display. The antenna may have a directly fed arm formed from the segment. The antenna may also have a parasitic arm. The parasitic arm may have a first end coupled to the conductive plate and may have a second end opposite the first end. The second end may be separated from the segment by a gap. The gap may form a distributed capacitance between the segment and ground through the parasitic arm. The directly fed arm may indirectly feed the parasitic arm via capacitive coupling across the gap. The parasitic arm may be formed from conductive traces on a flexible printed circuit, from folded sheet metal, or from other conductive material in the device. The parasitic arm may broaden the bandwidth of the antenna to cover a sufficiently wide range of frequencies (e.g., for covering a 2.4 GHz Wi-Fi band, a 5 GHz Wi-Fi band, and a Wi-Fi 6E band).

The electronic device may have an antenna with a tuning element formed from a distributed capacitance between a segment of the peripheral conductive housing structures and the conductive plate. The distributed capacitance may be defined at least in part by a protrusion from the segment. The protrusion may include openings for drawing in some of the dielectric material in the slot. The antenna may be fed using a flexible printed circuit having distributed shut capacitances between ground and a signal conductor of the transmission line path for the antenna.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a cross-sectional side view of an electronic device having housing structures that may be used in forming antenna structures in accordance with some embodiments.

FIG. 5 is a front interior view of the upper end of an electronic device with an illustrative antenna having a directly fed arm formed from peripheral conductive housing structures and having a parasitic arm formed from conductive traces on a flexible printed circuit in accordance with some embodiments.

FIG. 6 is a cross-sectional side view showing one example of how an illustrative parasitic arm formed from conductive traces on a flexible printed circuit may be disposed within an electronic device in accordance with some embodiments.

FIG. 7 is a front interior view of the upper end of an illustrative electronic device with an illustrative antenna having a directly fed arm formed from peripheral conductive housing structures and having a parasitic arm formed from folded sheet metal in accordance with some embodiments.

FIG. 8 is a cross-sectional side view showing one example of how an illustrative parasitic arm formed from folded sheet metal may be disposed within an electronic device in accordance with some embodiments.

FIG. 9 is a plot of antenna performance (efficiency) as a function of frequency that illustrates how a distributed capacitance formed by an illustrative parasitic arm may optimize antenna performance relative to antennas having discrete tuning capacitors in accordance with some embodiments.

FIG. 10 is a plot of antenna performance (efficiency) as a function of frequency that illustrates how a parasitic arm of the types shown in FIGS. 5-8 may optimize antenna performance across a frequency band of interest in accordance with some embodiments.

FIG. 11 is a front interior view of the upper end of an electronic device with an illustrative antenna that includes a tuning element formed from a distributed capacitance in accordance with some embodiments.

FIG. 12 is a cross-sectional side view showing how an illustrative antenna may include a distributed capacitance between peripheral conductive housing structures and a conductive support plate.

FIG. 13 is a top view of an illustrative conductive housing protrusion for a distributed capacitor that includes a set of circular slots for receiving dielectric material in accordance with some embodiments.

FIG. 14 is a top view of an illustrative conductive housing protrusion for a distributed capacitor that includes an elongated slot for receiving dielectric material in accordance with some embodiments.

FIG. 15 is a top view of an illustrative conductive housing protrusion for a distributed capacitor that includes multiple elongated slots for receiving dielectric material in accordance with some embodiments.

FIG. 16 is a top view of an illustrative conductive housing protrusion for a distributed capacitor that includes open slots and prongs for receiving dielectric material in accordance with some embodiments.

FIG. 17 is a plot of antenna performance (efficiency) as a function of frequency that illustrates how the distributed capacitance of FIGS. 11-17 may optimize antenna performance in one or more frequency bands in accordance with some embodiments.

FIG. 18 is an interior perspective view of an illustrative antenna that is fed by a flexible printed circuit having conductive traces that form distributed capacitances in accordance with some embodiments.

FIG. 19 is a plot of antenna performance (efficiency) as a function of frequency that illustrates how the distributed capacitance of FIG. 18 may optimize antenna performance in one or more frequency bands in accordance with some embodiments.

### DETAILED DESCRIPTION

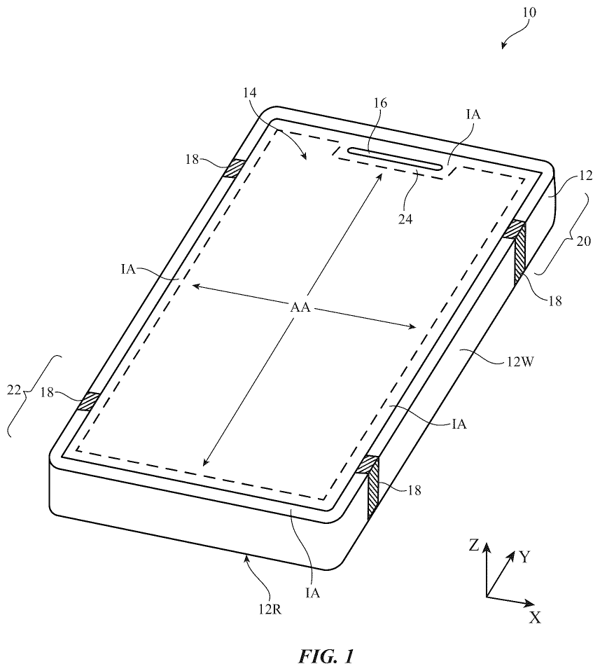

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device (e.g., virtual, augmented, or mixed reality glasses or goggles), or another wearable or miniature device, a handheld device such as a cellular telephone, a media player, or another small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, include a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as notch 24 that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 24 of inactive area IA). Notch 24 may be a substantially rectangular region that is surrounded (defined) on three sides by active area AA and on a fourth side by peripheral conductive housing structures 12W. Alternatively, notch 24 may be defined on all sides by (e.g., may be surrounded and enclosed by) active area AA (e.g., notch 24 may form an inactive island in the pixel circuitry of display 14). One or more sensors may be aligned with notch 24 and may transmit and/or receive light through display 14 within notch 24.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is illustrative and non-limiting.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is illustrative and non-limiting. If desired, housing 12 may have other shapes (e.g., a square shape, cylindrical shape, spherical shape, combinations of these and/or different shapes, etc.).

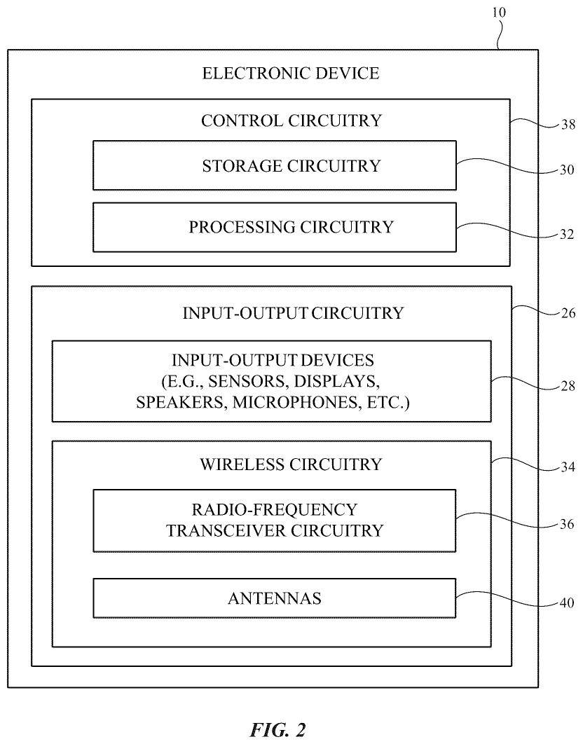

A schematic diagram of illustrative components that may be used in device 10 is shown in FIG. 2. As shown in FIG. 2, device 10 may include control circuitry 38. Control circuitry 38 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 38 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 38 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 38 may be used to run software on device 10 such as internet browsing applications, voice-over-internet-protocol (VOIP) telephone call applications, email applications, media playback applications, operating system functions, etc. To support interactions with external equipment, control circuitry 38 may be used in implementing communications protocols. Communications protocols that may be implemented using control circuitry 38 include internet protocols, wireless local area network protocols (e.g., IEEE 802.11 protocols-sometimes referred to as Wi-Fi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 26. Input-output circuitry 26 may include input-output devices 28. Input-output devices 28 may be used to allow data to be supplied to device 10 and to allow data to be provided from device 10 to external devices. Input-output devices 28 may include user interface devices, data port devices, sensors, and other input-output components. For example, input-output devices 28 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 28 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 26 may include wireless circuitry such as wireless circuitry 34 for wirelessly conveying radio-frequency signals. While control circuitry 38 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 38 (e.g., portions of control circuitry 38 may be implemented on wireless circuitry 34). As an example, control circuitry 38 may include baseband processor circuitry or other control components that form a part of wireless circuitry 34.

Wireless circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless circuitry 34 may include radio-frequency transceiver circuitry 36 for handling transmission and/or reception of radio-frequency signals within corresponding frequency bands at radio frequencies (sometimes referred to herein as communications bands or simply as “bands”). The frequency bands handled by radio-frequency transceiver circuitry 36 may include wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHZ WLAN band (e.g., from 5180 to 5825 MHZ), a Wi-Fi® 6E band (e.g., from 5925-7125 MHz), and/or other Wi-Fi® bands (e.g., from 1875-5160 MHZ), wireless personal area network (WPAN) frequency bands such as the 2.4 GHz Bluetooth® band or other WPAN communications bands, cellular telephone communications bands such as a cellular low band (LB) (e.g., 600 to 960 MHz), a cellular low-midband (LMB) (e.g., 1400 to 1550 MHZ), a cellular midband (MB) (e.g., from 1700 to 2200 MHZ), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHZ), 3G bands, 4G LTE bands, 3GPP 5G New Radio Frequency Range 1 (FR1) bands below 10 GHZ, 3GPP 5G New Radio (NR) Frequency Range 2 (FR2) bands between 20 and 60 GHz, other centimeter or millimeter wave frequency bands between 10-300 GHz, 3GPP 6G frequency bands (e.g., between around 100 GHz-10 THz or bands lower than 100 GHz) near-field communications frequency bands (e.g., at 13.56 MHZ), satellite navigation frequency bands such as the Global Positioning System (GPS) L1 band (e.g., at 1575 MHz), L2 band (e.g., at 1228 MHz), L3 band (e.g., at 1381 MHZ), L4 band (e.g., at 1380 MHZ), and/or L5 band (e.g., at 1176 MHZ), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHZ), communications bands under the family of 3GPP wireless communications standards, communications bands under the IEEE 802.XX family of standards, satellite communications bands such as an L-band, S-band (e.g., from 2-4 GHZ), C-band (e.g., from 4-8 GHZ), X-band, Ku-band (e.g., from 12-18 GHZ), Ka-band (e.g., from 26-40 GHZ), etc., industrial, scientific, and medical (ISM) bands such as an ISM band between around 900 MHz and 950 MHz or other ISM bands below or above 1 GHZ, one or more unlicensed bands, one or more bands reserved for emergency and/or public services, and/or any other desired frequency bands of interest. Wireless circuitry 34 may also be used to perform spatial ranging operations if desired.

The UWB communications handled by radio-frequency transceiver circuitry 36 may be based on an impulse radio signaling scheme that uses band-limited data pulses. Radio-frequency signals in the UWB frequency band may have any desired bandwidths such as bandwidths between 499 MHz and 1331 MHz, bandwidths greater than 500 MHZ, etc. The presence of lower frequencies in the baseband may sometimes allow ultra-wideband signals to penetrate through objects such as walls. In an IEEE 802.15.4 system, for example, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals).

Radio-frequency transceiver circuitry 36 may include respective transceivers (e.g., transceiver integrated circuits or chips) that handle each of these frequency bands or any desired number of transceivers that handle two or more of these frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). Radio-frequency transceiver circuitry 36 may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

In general, radio-frequency transceiver circuitry 36 may cover (handle) any desired frequency bands of interest. As shown in FIG. 2, wireless circuitry 34 may include antennas 40. Radio-frequency transceiver circuitry 36 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. If desired, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals within a signal beam formed in a desired beam pointing direction that may be steered/adjusted over time). Different types of antennas may be used for different bands and combinations of bands.

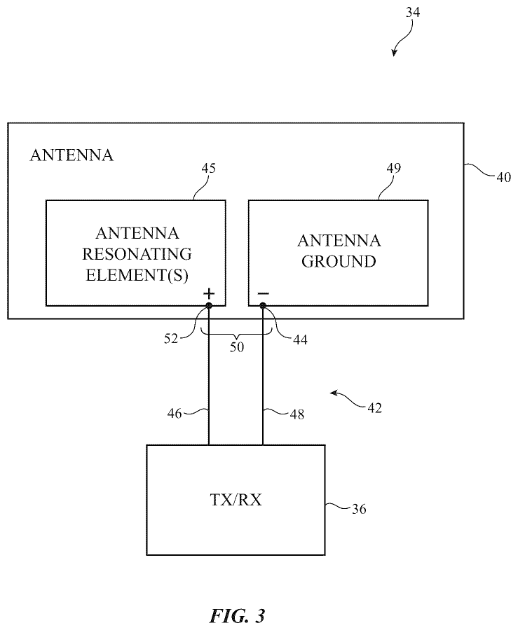

FIG. 3 is a schematic diagram showing how a given antenna 40 may be fed by radio-frequency transceiver circuitry 36. As shown in FIG. 3, antenna 40 may have a corresponding antenna feed 50. Antenna 40 may include one or more antenna resonating (radiating) elements 45 and an antenna ground 49. Antenna resonating element(s) 45 may include one or more radiating arms, slots, waveguides, dielectric resonators, patches, parasitic elements, indirect feed elements, and/or any other desired antenna radiators. Antenna feed 50 may include a positive antenna feed terminal 52 coupled to at least one antenna resonating element 45 and a ground antenna feed terminal 44 coupled to antenna ground 49. If desired, one or more conductive paths (sometimes referred to herein as ground paths, short paths, or return paths) may couple antenna resonating element(s) 45 to antenna ground 49.

Radio-frequency transceiver (TX/RX) circuitry 36 may be coupled to antenna feed 50 using a radio-frequency transmission line path 42 (sometimes referred to herein as transmission line path 42). Transmission line path 42 may include a signal conductor such as signal conductor 46 (e.g., a positive signal conductor). Transmission line path 42 may include a ground conductor such as ground conductor 48. Ground conductor 48 may be coupled to ground antenna feed terminal 44 of antenna feed 50. Signal conductor 46 may be coupled to positive antenna feed terminal 52 of antenna feed 50.

Transmission line path 42 may include one or more radio-frequency transmission lines. The radio-frequency transmission line(s) in transmission line path 42 may include stripline transmission lines (sometimes referred to herein simply as striplines), coaxial cables, coaxial probes realized by metalized vias, microstrip transmission lines, edge-coupled microstrip transmission lines, edge-coupled stripline transmission lines, waveguide structures, combinations of these, etc. Multiple types of radio-frequency transmission line may be used to form transmission line path 42. Filter circuitry, switching circuitry, impedance matching circuitry, phase shifter circuitry, amplifier circuitry, and/or other circuitry may be interposed on transmission line path 42, if desired. One or more antenna tuning components for adjusting the frequency response of antenna 40 in one or more bands may be interposed on transmission line path 42 and/or may be integrated within antenna 40 (e.g., coupled between the antenna ground and the antenna resonating element of antenna 40, coupled between different portions of the antenna resonating element of antenna 40, etc.).

If desired, one or more of the radio-frequency transmission lines in transmission line path 42 may be integrated into ceramic substrates, rigid printed circuit boards, and/or flexible printed circuits. In one suitable arrangement, the radio-frequency transmission lines may be integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All the multiple layers of the laminated structures may be batch laminated together (e.g., in a single pressing process) without adhesive (e.g., as opposed to performing multiple pressing processes to laminate multiple layers together with adhesive).

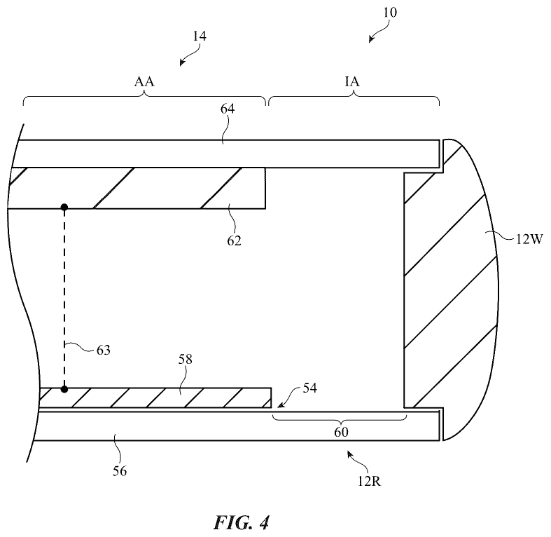

If desired, conductive electronic device structures such as conductive portions of housing 12 (FIG. 1) may be used to form at least part of one or more of the antennas 40 in device 10. FIG. 4 is a cross-sectional side view of device 10, showing illustrative conductive electronic device structures that may be used in forming one or more of the antennas 40 in device 10.

As shown in FIG. 4, peripheral conductive housing structures 12W may extend around the lateral periphery of device 10 (e.g., as measured in the X-Y plane of FIG. 1). Peripheral conductive housing structures 12W may extend from rear housing wall 12R (e.g., at the rear face of device 10) to display 14 (e.g., at the front face of device 10). In other words, peripheral conductive housing structures 12W may form conductive sidewalls for device 10, a first of which is shown in the cross-sectional side view of FIG. 4 (e.g., a given sidewall that runs along an edge of device 10 and that extends across the width or length of device 10).

Display 14 may have a display module such as display module 62 (sometimes referred to as a display panel). Display module 62 may include pixel circuitry, touch sensor circuitry, force sensor circuitry, and/or any other desired circuitry for forming active area AA of display 14. Display 14 may include a dielectric cover layer such as display cover layer 64 that overlaps display module 62. Display cover layer 64 may include plastic, glass, sapphire, ceramic, and/or any other desired dielectric materials. Display module 62 may emit image light and may receive sensor input (e.g., touch and/or force sensor input) through display cover layer 64. Display cover layer 64 and display 14 may be mounted to peripheral conductive housing structures 12W. The lateral area of display 14 that does not overlap display module 62 may form inactive area IA of display 14.

As shown in FIG. 4, rear housing wall 12R may be mounted to peripheral conductive housing structures 12W (e.g., opposite display 14). Rear housing wall 12R may include a dielectric cover layer such as dielectric cover layer 56. Dielectric cover layer 56 may include glass, plastic, sapphire, ceramic, one or more dielectric coatings, or other dielectric materials. If desired, conductive material may be layered onto some of the interior lateral surface of dielectric cover layer 56. Dielectric cover layer 56 may extend across an entirety of the width of device 10 and/or an entirety of the length of device 10. If desired, dielectric cover layer 56 may be provided with pigmentation and/or an opaque masking layer (e.g., an ink layer) that helps to hide the interior of device 10 from view.

If desired, the housing for device 10 may also include one or more conductive support plates. For example, the housing for device 10 may include a conductive support such as conductive support plate 58. Conductive support plate 58 may form a part of rear housing wall 12R (e.g., may be adhered to dielectric cover layer 56) or may be separate from rear housing wall 12R (e.g., there may be an air gap between conductive support plate 58 and dielectric cover layer 56). Conductive support plate 58 is sometimes also referred to herein as conductive chassis 58, conductive plate 58, conductive wall 58, conductive housing wall 58, conductive housing layer 58, conductive back plate 58, or conductive layer 58.

Conductive support plate 58 may be layered onto dielectric cover layer 56 without adhesive that adheres conductive support plate 58 to dielectric cover layer 56 or may be separated from dielectric cover layer 56 by a non-zero distance (e.g., an air gap). This may, for example, allow dielectric cover layer 56 and/or rear housing wall 12R to be easily removed from device 10 (e.g., to repair and/or replace components within the interior of device 10). Alternatively, conductive support plate 58 may be adhered to dielectric cover layer 56 (e.g., may form a part of rear housing wall 12R). Alternatively, dielectric cover layer 56 may be omitted (e.g., conductive support plate 58 may form rear housing wall 12R and the rear face of device 10).

Conductive support plate 58 may extend across an entirety of the width of device 10 (e.g., between the left and right edges of device 10 as shown in FIG. 1). Conductive support plate 58 may, if desired, be formed from a separate conductor than peripheral conductive housing structures 12W (e.g., conductive support plate 58 and peripheral conductive housing structures 12W are not formed from an integral piece of metal) to help facilitate removal of rear housing wall 12R, for example. One or more components may be supported by conductive support plate 58 (e.g., logic boards such as a main logic board, a battery, a speaker, a camera, a ringer or haptic engine, etc.). Conductive support plate 58 may contribute to the mechanical strength of device 10 (e.g., to prevent external twisting or bending forces from damaging device 10). Conductive support plate 58 may be formed from metal (e.g., stainless steel, aluminum, titanium, etc.), for example.

Conductive support plate 58 may have an edge 54 that is separated from peripheral conductive housing structures 12W by dielectric-filled slot 60 (sometimes referred to herein as opening 60, gap 60, or aperture 60). Slot 60 may be filled with air, plastic, polymer, epoxy, ceramic, or other dielectric materials. Conductive housing structures such as conductive support plate 58, conductive portions of display module 62, and/or peripheral conductive housing structures 12W (e.g., the portion of peripheral conductive housing structures 12W opposite conductive support plate 58 and display module 62 at slot 60) may be used to form antenna structures for one or more of the antennas 40 in device 10.

For example, peripheral conductive housing structures 12W may form an antenna resonating element arm (e.g., an inverted-F antenna resonating element arm and/or one or more edges of a slot antenna resonating element) in the antenna resonating element 45 (FIG. 3) of an antenna 40 in device 10. Conductive support plate 58 and/or display module 62 may be used to form the antenna ground 49 (FIG. 3) for one or more of the antennas 40 in device 10 and/or to form one or more edges of slot antenna resonating elements for the antennas in device 10. One or more conductive interconnect structures 63 may electrically couple conductive support plate 58 to conductive structures in display module 62 (sometimes referred to herein as conductive display structures) and/or to other grounded components in device 10 so that each of these elements form part of the antenna ground. The conductive structures in display module 62 may include a conductive frame, bracket, or support plate for display module 62, shielding layers in display module 62, ground traces in display module 62, pixel circuitry, etc. Conductive interconnect structures may also be used to ground different points on peripheral conductive housing structures 12W (e.g., to short those points to display module 62 and/or conductive support plate 58).

Conductive interconnect structures 63 may hold the conductive structures in display module 62 and conductive support plate 58 to a common ground or reference potential (e.g., as a system ground for device 10 that is used to form part of antenna ground 49 of FIG. 3). Conductive interconnect structures 63 may therefore sometimes be referred to herein as grounding structures 63, grounding interconnect structures 63, or vertical grounding structures 63. Conductive interconnect structures 63 may include conductive traces, conductive pins, conductive springs (e.g., y-springs or spring fingers), conductive prongs (e.g., conductive blades that mate with conductive spring fingers such as y-springs), conductive brackets, conductive screws, conductive clips, conductive tape, conductive wires, conductive traces, conductive foam, conductive adhesive, solder, welds, metal members (e.g., sheet metal members), contact pads, conductive vias, conductive portions of one or more components mounted to conductive support plate 58, and/or any other desired conductive interconnect structures.

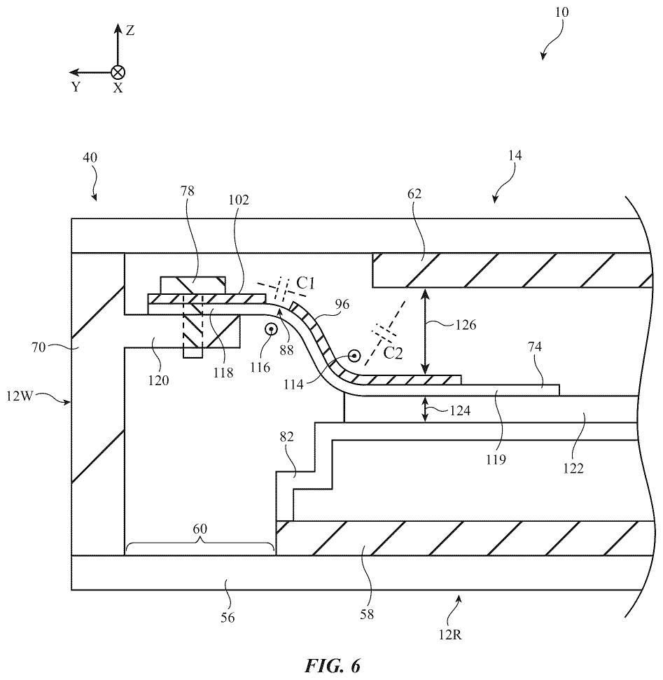

The example of FIG. 6 in which rear housing wall 12R includes dielectric cover layer 56 is illustrative and non-limiting. If desired, dielectric cover layer 56 may be omitted (e.g., conductive support plate 58 may form rear housing wall 12R and a rear exterior surface of device 10). In these implementations, slot 60 may be filled with dielectric material (e.g., plastic, ceramic, glass, epoxy, resin, etc.) that lies flush with the exterior surface of conductive support plate 58 and/or the lower edge of peripheral conductive housing structures 12W.

In practice, it may be desirable for an antenna in device 10 to radiate through display 14 and/or rear housing wall 12R of device 10. However, if care is not taken, the presence of conductive components in the vicinity of the antenna can block or undesirably limit the performance of the antenna in conveying radio-frequency signals through display 14 and/or rear housing wall 12R, particularly when the active area AA of display 14 is as large as possible. To mitigate these issues and to maximize the bandwidth of the antenna, the antenna may include both a directly fed arm formed from peripheral conductive housing structures 12W and a parasitic arm that is capacitively coupled to the directly fed arm.

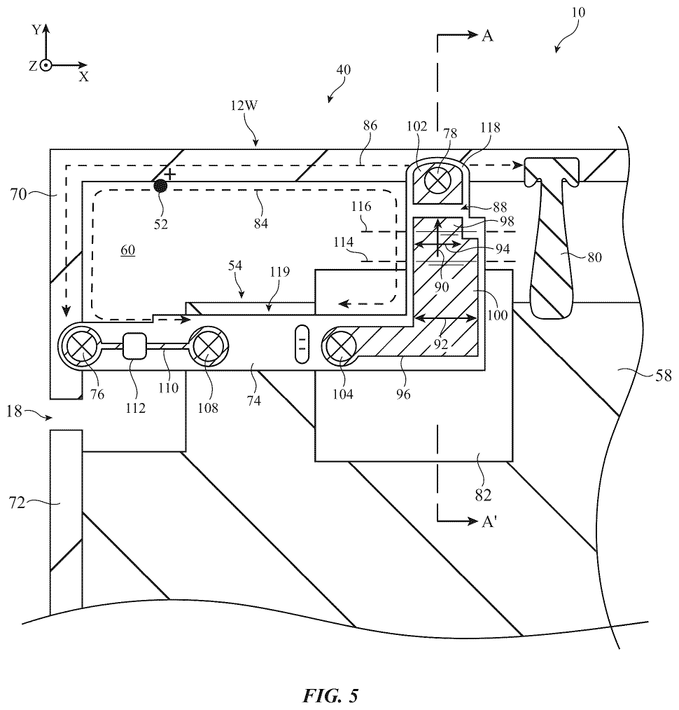

FIG. 5 is a top interior view showing one example of how device 10 may include an antenna with both a directly fed arm formed from peripheral conductive housing structures 12W and a parasitic arm that is capacitively coupled to the directly fed arm. In the example of FIG. 5, dielectric cover layer 56 of rear housing wall 12R and display 14 have been omitted for the sake of clarity.

As shown in FIG. 5, peripheral conductive housing structures 12W may include a first conductive sidewall at the left edge of device 10 and a second conductive sidewall at the top edge of device 10. Peripheral conductive housing structures 12W may be segmented (divided) by one or more dielectric-filled gaps 18. Gap 18 may be filled with plastic, ceramic, sapphire, glass, epoxy, resin, or other dielectric materials. The dielectric material in gap 18 may lie flush with peripheral conductive housing structures 12W at the exterior surface of device 10 if desired.

Gap 18 may divide the first conductive sidewall to separate segment 72 of peripheral conductive housing structures 12W from segment 70 of peripheral conductive housing structures 12W. Conductive support plate 58 may extend across the length and width of device 10 (e.g., within the X-Y plane). Conductive support plate 58 may have an upper edge 54 that is separated from segment 70 by slot 60. Edge 54 may extend across the width of device 10 (e.g., across substantially all of the width of device 10 and substantially parallel to the X-axis). Conductive support plate 58 may have a left edge that is coupled to segment 72 of peripheral conductive housing structures 12W. If desired, segment 72 and conductive support plate 58 may be formed from different integral portions of a single piece of metal (e.g., in a unibody configuration).

Slot 60 may have an elongated shape that extends from gap 18 to an additional gap on the opposite side of device 10 (see, e.g., gaps 18 of FIG. 1). If desired, some of slot 60 may extend below gap 18 between conductive support plate 58 and segment 72 of peripheral conductive housing structures 12W. Alternatively, slot 60 may end at gap 18. Device 10 may include one or more components mounted to conductive support plate 58 such as speaker 82.

Device 10 may include a printed circuit board such as flexible printed circuit 74 overlapping slot 60 and/or conductive support plate 58. Flexible printed circuit 74 may have a first tail (arm or branch) 118 and a second tail (arm or branch) 119 extending away from tail 118. Tail 119 may be coupled to a first point (location) on segment 70 of peripheral conductive housing structures 12W by conductive interconnect structure 76 (e.g., along the first or left wall of peripheral conductive housing structures 12W). Tail 118 may be coupled to a second point (location) on segment 70 by conductive interconnect structure 78 (e.g., along a second or top wall of peripheral conductive housing structures 12W). Conductive interconnect structures 76 and 78 may mechanically secure, attach, or otherwise affix flexible printed circuit 74 to segment 70.

Flexible printed circuit 74 may also be coupled to conductive support plate 58 by additional conductive interconnect structures such as conductive interconnect structure 108 and conductive interconnect structure 104. Conductive interconnect structures 108 and 104 may mechanically secure, attach, or otherwise affix flexible printed circuit 74 to conductive support plate 58. Tail 119 may extend over slot 60 from conductive support plate 58 to the end of segment 70 at or adjacent gap 18. Tail 118 may extend over slot 60 from conductive support plate 58 to the second point on segment 70, adjacent to conductive interconnect structure 80.

If desired, flexible printed circuit 74 may be bent or folded around one or more parallel and/or non-parallel axes. For example, as shown in FIG. 5, tail 118 of flexible printed circuit 74 may be folded downwards around a first axis 116 (e.g., parallel to the X-axis) and upwards around a second axis 114 parallel to first axis 116. Folding flexible printed circuit 74 may help to route the flexible printed circuit around other components in device 10, for example.

Conductive interconnect structure 80 may electrically couple a third point segment 70 to conductive display structures such as display module 62 (FIG. 4) and/or conductive support plate 58. The second point on segment 70 (conductive interconnect structure 78) may be interposed on segment 70 between the positive antenna feed terminal 52 for antenna 40 and the third point on segment 70 (conductive interconnect structure 80). Positive antenna feed terminal 52 may be interposed on segment 70 between the second point (conductive interconnect structure 78) and the first point on segment 70 (conductive interconnect structure 76). The first point on segment 70 (conductive interconnect structure 76) may be interposed on segment 70 between gap 18 and positive antenna feed terminal 52.

Conductive interconnect structures 76, 108, 104, 78, and 80 may include conductive pins, conductive springs (e.g., y-springs or spring fingers), conductive prongs (e.g., conductive blades that mate with conductive spring fingers such as y-springs), conductive brackets, conductive screws, conductive clips, conductive tape, conductive wires, conductive traces, conductive foam, conductive adhesive, solder, welds, metal members (e.g., sheet metal members), contact pads, conductive vias, and/or other conductive interconnect structures. As one example, conductive interconnect structures 76, 108, 104, and 78 may include conductive screws and conductive interconnect structure 80 may include a conductive spring finger. Conductive interconnect structures 76, 108, 104, 78, and 80 are sometimes also referred to herein simply as conductive interconnects.

Flexible printed circuit 74 may include a conductive trace 110 on tail 119. Conductive trace 110 may couple conductive interconnect structure 76 to conductive interconnect structure 108. Conductive interconnect structure 76 may electrically couple (e.g., short) the first point on segment 70 to ground (e.g., conductive interconnect structure 58) through conductive trace 110 and conductive interconnect structure 108. Put differently, conductive interconnect structures 76 and 108 and conductive trace 110 may form an electrical return path from segment 70 to ground.

Device 10 may include an antenna 40 integrated into conductive support plate 58 and segment 70 of peripheral conductive housing structures 12W for conveying radio-frequency signals through the front and/or rear faces of device 10. Antenna 40 may have an antenna resonating element (e.g., antenna resonating element 45 of FIG. 3) that includes at least a first directly-fed antenna arm and a second parasitically-fed (indirectly fed) antenna arm. For example, as shown in FIG. 5, antenna 40 may include a directly fed arm formed from segment 70. Antenna 40 may also include a parasitic arm 96 formed from conductive traces on tail 118 of flexible printed circuit 74.

The positive antenna feed terminal 52 for antenna 40 may be coupled to segment 70 between conductive interconnect structures 76 and 78. Positive antenna feed terminal 52 may directly feed segment 70 of peripheral conductive housing structures 12W (e.g., the signal conductor of the corresponding transmission line path may be galvanically connected to segment 70 at positive antenna feed terminal 52 and antenna current may flow between the signal conductor and segment 70 while antenna 40 conveys radio-frequency signals). The antenna current may flow along segment 70 between the first point (conductive interconnect structure 76) and the third point (conductive interconnect structure 80), as shown by arrow 86. At the first point of segment 70, the antenna current on segment 70 may be shorted to ground (e.g., conductive support plate 58) through conductive interconnect structure 76, conductive trace 110, and conductive interconnect structure 108. At the third point of segment 70, the antenna current on segment 70 may be shorted to ground (e.g., display module 62 of FIG. 4 and/or conductive support plate 58) through conductive interconnect structure 80. The antenna current may also flow along the ground (e.g., at edge 54 of conductive support plate 58 and/or display module 62 of FIG. 4). This may cause a portion of slot 60 between conductive interconnect structures 76 and 80 to contribute one or more electromagnetic slot antenna resonating modes (e.g., aperture modes) to the frequency response of antenna 40 (e.g., serving to broaden the bandwidth of antenna 40).

Given the presence of other components in device 10, the resonating characteristic of segment 70 may not be sufficient on its own for antenna 40 to cover all frequencies within a given frequency range of interest such as a frequency range from around 2000 MHz to around 7000 MHz (e.g., for configuring antenna 40 to concurrently cover each of a Wi-Fi 2.4 GHz band, a Wi-Fi 5 GHz band, and a Wi-Fi 6E band). Parasitic arm 96 of antenna 40 may serve to further broaden the bandwidth of antenna 40.

As shown in FIG. 5, parasitic arm 96 may be formed from conductive traces on tail 118 of flexible printed circuit 74. Tail 118 of flexible printed circuit 74 may include a conductive contact pad such as contact pad 102. Conductive interconnect structure 78 may be mounted to contact pad 102, forming a galvanic connection between contact pad 102 and segment 70. Parasitic arm 96 extends from a first end to an opposing second end. The first end is separated from contact pad 102 on flexible printed circuit 74 by a dielectric-filled gap such as gap 88 (e.g., the first end of parasitic arm 96 defines a first edge of gap 88 whereas contact pad 102 defines an opposing second edge of gap 88, such that gap 88 has opposing edges defined by contact pad 102 and parasitic arm 96). Gap 88 is free of conductive traces and other conductive material on flexible printed circuit 74 (e.g., contact pad 102 and peripheral conductive housing structures 12W are not directly or galvanically connected to parasitic arm 96). The second end of parasitic arm 96 is coupled to ground (e.g., shorted to conductive support plate 58) by conductive interconnect structure 104.

Gap 88 forms a distributed capacitance between contact pad 102 and parasitic arm 96 (e.g., contact pad 102 and parasitic arm 96 may form a distributed capacitor). Put differently, parasitic arm 96 is capacitively coupled to contact pad 102 and thus conductive interconnect structure 78 and the second point on segment 70 via a near-field electromagnetic (capacitive) coupling across gap 88. The distributed capacitance is coupled in series between the third point on segment 70 and ground through parasitic arm 96. The conductive traces that form parasitic arm 96 may include a first portion 98 at gap 88 and a second portion 100 between first portion 98 and conductive interconnect structure 104. First portion 98 may have width 94. Second portion 100 may have width 92 (e.g., greater than width 90). Gap 88 may have a width 90 (e.g., from contact pad 102 to parasitic arm 96). This is illustrative and, in general, the conductive traces that form parasitic arm 96 may have any desired number of segments with different widths, may follow any desired path, may have any desired shape, and may have any desired number of curved and/or straight edges.

When antenna 40 is conveying radio-frequency signals, the directly fed antenna arm formed from segment 70 may indirectly feed parasitic arm 96 via near-field electromagnetic (capacitive) coupling across gap 88. Some of the antenna current may flow between contact pad 102 and parasitic arm 96 across gap 88 (e.g., at frequencies passed by the distributed capacitance of gap 88) and thus between conductive interconnect structure 78 and ground (conductive interconnect structure 104). Antenna current on parasitic arm 96 may contribute one or more additional resonances to the frequency response of antenna 40. These additional resonances may be given by the shape and length of parasitic arm 96 and/or may include one or more radiating slot (aperture) modes associated with current flowing around the portion of slot 60 between parasitic arm 96 and conductive trace 110, as shown by arrow 84.

Width 94, width 92, and/or width 90 may be selected to tune the distributed capacitance between the third point on segment 70 (conductive interconnect structure 78) and ground (conductive interconnect structure 104) and/or the impedance of parasitic arm 96, which in turn tunes the frequency contribution made by parasitic arm 96 to antenna 40. In this way, the overall bandwidth of antenna 40 may be broadened to cover a sufficiently wide bandwidth (e.g., to cover each of a Wi-Fi 2.4 GHz band, a Wi-Fi 5 GHz band, and a Wi-Fi 6E band). The distributed capacitance formed by gap 88 may configure parasitic arm 96 to contribute desired frequencies to the response of antenna 40 without the use of bulky surface-mount technology (SMT) capacitors on flexible printed circuit 74, thereby minimizing the size and cost of flexible printed circuit 74 and allowing sufficient room for other components in device 10. Parasitic arm 96 may also serve to electrically extend the radiating length of slot 60 and/or antenna 40 without increasing the footprint of slot 60 and/or antenna 40.

If desired, tuning circuitry 112 may be disposed on conductive trace 110 of flexible printed circuit 74. Tuning circuitry 112 may include one or more SMT components such as capacitors, resistors, inductors, switches, etc. Tuning circuitry 112 may include one or more aperture tuners and/or impedance matching circuitry. Tuning circuitry 112 may be adjusted to tune the frequency response of antenna 40. If desired, tuning circuitry 112 may have a state in which an open circuit (infinite) impedance is disposed on conductive trace 110 (e.g., configuring segment 70 to form an inverted-F antenna resonating element arm). If desired, tuning circuitry 112 may have a state in which a short circuit (zero) impedance is disposed on conductive trace 110 (e.g., forming a short circuit return path between the first point on segment 70 and ground). If desired, tuning circuitry 112 may have one or more states in which different non-zero and non-infinite impedances are disposed on conductive trace 110. If desired, additional conductive interconnect structures may be disposed on flexible printed circuit 74 for coupling conductive traces to display module 62 (FIG. 4) and/or other components.

Parasitic arm 96 is sometimes also referred to herein as parasitic antenna resonating element 96, parasitic branch 96, parasitic resonating branch 96, parasitic radiating branch 96, parasitic antenna resonating arm 96, parasitic antenna radiating element 96, parasitic antenna radiating arm 96, parasitic element 96, parasitic 96, parasitic path 96, parasitic radiator 96, parasitic resonator 96, indirectly fed arm 96, indirectly fed antenna resonating element 96, indirectly fed antenna radiating element 96, or indirectly fed element 96. The portion of segment 70 between conductive interconnect structures 76 and 80 is sometimes also referred to herein as a directly fed arm, a directly fed antenna resonating element, a directly fed antenna resonating arm, a directly fed antenna radiating element, a directly fed antenna radiating arm, a directly fed arm, a directly fed radiator, or a directly fed resonator of antenna 40. The portion of slot 60 between conductive trace 110 and parasitic arm 96 (e.g., as shown by arrow 84) is sometimes also referred to herein as a radiating slot, a resonating slot, a resonant slot, an antenna resonating element, an antenna radiating element, a slot element, a radiating aperture, a resonating aperture, or an antenna slot of antenna 40. Since slot 60 is disposed at the rear face of device 10 (see, e.g., FIG. 4), slot 60 may radiate directly through the rear face of device 10.

FIG. 6 is a cross-sectional side view of device 10 (e.g., as viewed along line AA′ of FIG. 5) showing how parasitic arm 96 may be integrated into device 10. As shown in FIG. 6, device 10 may include a component such as speaker 82. Speaker 82 may include a dielectric speaker housing, a conductive speaker can or plate, injection-molded plastic, an acoustic cavity, a speaker driver, and/or other components that produce sound that is emitted by device 10 through a corresponding speaker port. More generally, speaker 82 may be replaced with any desired components in device 10.

Peripheral conductive housing structures 12W may include a datum portion such as ledge 120 at or facing display 14. Display 14 may be mounted to peripheral conductive housing structures 12W opposite rear housing wall 12R. Tail 118 of flexible printed circuit 74 may be mounted to ledge 120. Conductive interconnect structure 78 (e.g., a conductive screw) may extend through an opening in contact pad 102, flexible printed circuit 74, and ledge 120 and may mechanically attach tail 118 to ledge 120. Conductive interconnect structure 78 may also electrically couple contact pad 102 to ledge 120 and thus segment 70 of peripheral conductive housing structures 12W. Gap 88 may establish a distributed capacitance C1 between parasitic arm 96 and contact pad 102 (or equivalently the directly fed arm formed from segment 70). Gap 88 may be located at or across a bend in flexible printed circuit 74 or may, if desired, be formed on a planar portion of flexible printed circuit 74.

Tail 118 of flexible printed circuit 74 may be folded, bent, or wrapped downwards around axis 116. Tail 118 may also be folded, bent, or wrapped upwards around axis 114. Tail 119 of flexible printed circuit 74 may overlap speaker 82 and may be mounted to speaker 82. As shown in the example of FIG. 6, a dielectric support structure or carrier such as shim 122 may be layered onto speaker 82 and tail 119 of flexible printed circuit 74 may be mounted to shim 122. If desired, flexible printed circuit 74 may be attached to shim 122 using a layer of adhesive or other interconnect structures (not shown).

Shim 122 has a thickness 124. Thickness 124 may be selected to separate parasitic arm 96 from (grounded) conductive structures in display module 62 by height 126. Height 126 may be selected to establish a corresponding distributed capacitance C2 between parasitic arm 96 and display module 62. Distributed capacitance C2 may be selected (e.g., via suitable configuration of the thickness 124 of shim 122 and thus height 126) and distributed capacitance C1 may be selected (e.g., via suitable selection of widths 90, 92, and/or 94 of FIG. 5 and/or suitable selection of a fold in flexible printed circuit 74 at gap 88) to tune the frequency response of parasitic arm 96 and thus antenna 40 to cover desired frequencies. Alternatively, shim 122 may be omitted and tail 119 of flexible printed circuit 74 may be layered directly onto speaker 82. If desired, a layer of adhesive or other interconnects may secure flexible printed circuit 74 to speaker 82 (or other device components).

Contact pad 102 and parasitic arm 96 may be formed from respective conductive traces on the surface of flexible printed circuit 74 and/or may be formed from conductive traces within flexible printed circuit 74. If desired, contact pad 102 and/or parasitic arm 96 may include conductive traces on one or more layers of flexible printed circuit 74 and may, if desired, include flooded include vias (copper) that couples different layers of conductive traces together.

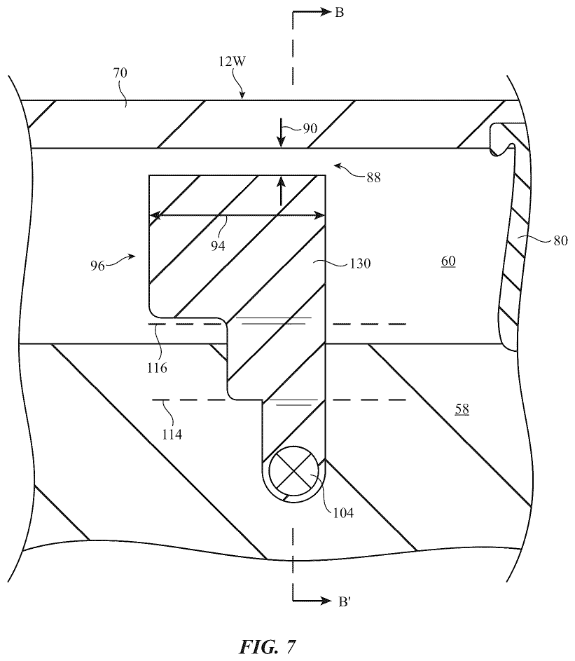

The examples of FIGS. 5 and 6 in which parasitic arm 96 is formed from conductive traces on flexible printed circuit 74 are illustrative and non-limiting. If desired, parasitic arm 96 may be formed from folded sheet metal. FIG. 7 is a top view showing one example of how parasitic arm 96 may be formed from folded sheet metal. In the example of FIG. 7, components other than parasitic arm 96, peripheral conductive housing structures 12W, conductive interconnect structures 104 and 80, and conductive support plate 58 have been omitted for the sake of clarity.

As shown in FIG. 7, conductive interconnect structure 78 of FIG. 5 may be omitted and parasitic arm 96 may be formed from a folded piece of sheet metal such as sheet metal member 130. Sheet metal member 130 may be separated from the third location on segment 70 of peripheral conductive housing structures 12W by gap 88 having width 90. Sheet metal member 130 may have width 94 at gap 88 to establish the same distributed capacitance electrically coupled in series between segment 70 and conductive interconnect structure 104 as when parasitic arm 96 is implemented using conductive traces on flexible printed circuit 74 (see, e.g., FIGS. 5 and 6). The example of FIG. 7 is illustrative and non-limiting. If desired, sheet metal member 130 may have other shapes, additional folds, fewer folds, etc.

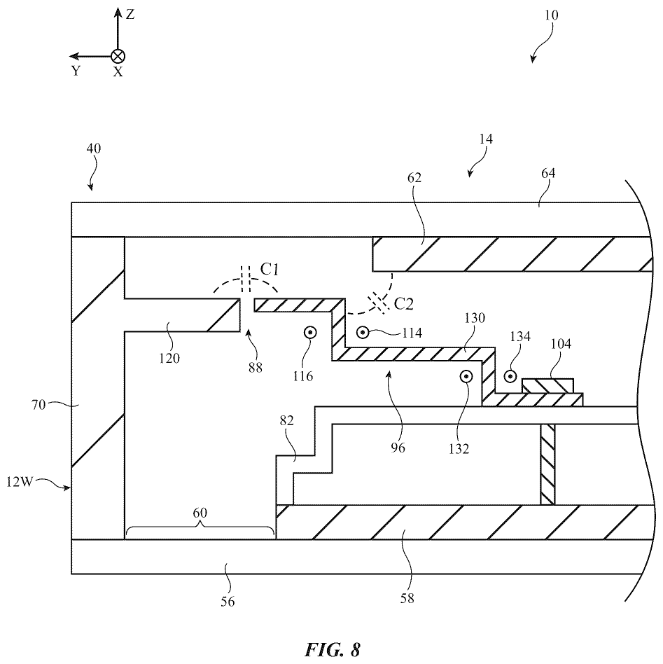

FIG. 8 is a cross-sectional side view of device 10 (e.g., as taken in the direction of arrows BB′ of FIG. 7) showing how sheet metal member 130 may be integrated into device 10. As shown in FIG. 8, sheet metal member 130 may have a first end at gap 88 (e.g., defining an edge of gap 88 and facing ledge 120) and an opposing second end at conductive interconnect structure 104. The first end of sheet metal member 130 may be laterally separated from segment 70 of peripheral conductive housing structures 12W (e.g., ledge 120) by gap 88. Conductive interconnect structure 104 may couple sheet metal member 130 to conductive support plate 58 (e.g., through or around speaker 82) and/or to other grounded structures in device 10.

If desired, sheet metal member 130 may include additional bends/folds such as a third bend downwards around axis 132 and a fourth bend upwards around axis 134. This is illustrative and, in general, sheet metal member 130 may include any desired number of folds. The placement of sheet metal member 130 may be selected to establish distributed capacitance C1 between sheet metal member 130 and peripheral conductive housing structures 12W and to establish distributed capacitance C2 between sheet metal member 130 and display module 62 (e.g., for tuning the frequency response of antenna 40). In the example of FIG. 8, sheet metal member 130 is mounted directly to speaker 82. If desired, sheet metal member 130 may be mounted to a dielectric support structure or carrier on speaker 82 (e.g., shim 122 of FIG. 6).

The example of FIGS. 7 and 8 is illustrative and non-limiting. If desired, sheet metal member 130 may be replaced with copper tape, metal foil, or conductive adhesive. More generally, any desired metal in proximity to the third location on segment 70 (e.g., metal portions of other device components such as a camera, speaker, ringer, vibrator, haptic engine, light sensor, microphone, etc.) may be held at a fixed distance (e.g., width 90) from peripheral conductive housing structures 12W to form parasitic arm 96 and to interpose distributed capacitance C1 between the third location on segment 70 and ground.

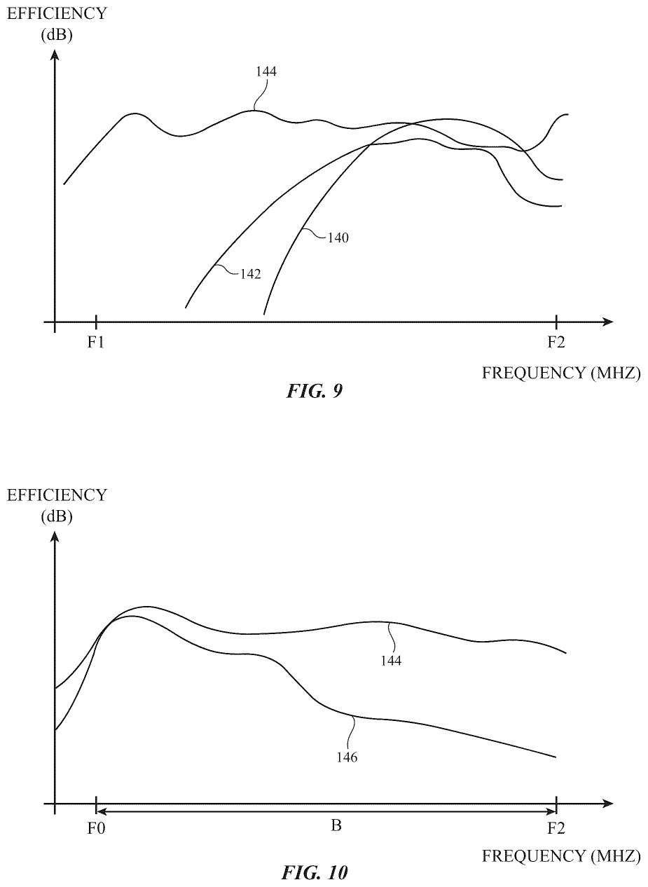

FIG. 9 is a plot of antenna performance (efficiency) as a function of frequency showing how distributed capacitance C1 may optimize antenna performance for antenna 40. Curve 140 plots the efficiency of antenna 40 in scenarios where a discrete 0.4 pF SMT capacitor is used to couple the third point on segment 70 to ground. Curve 142 plots the efficiency of antenna 40 in scenarios where a discrete 1 pF SMT capacitor is used to couple the third point on segment 70 to ground. Curve 144 plots the efficiency of antenna 40 in the implementations of FIGS. 5-8, in which parasitic arm 96 forms a distributed capacitance C1 between the third point on segment 70 and ground. As shown by curves 140-144, coupling a distributed capacitance between the third point on segment 70 and ground may serve to boost the efficiency of antenna 40 at relatively low frequencies between frequency F1 (e.g., 4800 MHZ) and frequency F2 (e.g., 8500 MHZ) relative to using a discrete SMT capacitor connected between peripheral conductive housing structures 12W and ground. The distributed capacitance also consumes less space within device 10, reduces device cost and complexity, and is more resistant to mechanical failure than discrete SMT capacitors, for example.

FIG. 10 is a plot of antenna performance (efficiency) as a function of frequency showing how parasitic arm 96 may optimize antenna performance for antenna 40. Curve 146 plots the efficiency of antenna 40 in scenarios where parasitic arm 96 is omitted from antenna 40. Curve 145 plots the efficiency of antenna 40 in the examples of FIGS. 5-8 where antenna 40 includes parasitic arm 96. As shown by curves 146 and 145, the combination of resonances of segment 70, slot 60, and parasitic arm 96 may serve to boost the efficiency of antenna 40 at relatively high frequencies within a frequency band B covered by antenna 40 (e.g., from a frequency F0 such as around 2000 MHz to a frequency F2 such as around 8500 MHz for covering at least a Wi-Fi 2.4 GHz band, a Wi-Fi 5 GHz band, and a Wi-Fi 6E band). The examples of FIGS. 9 and 10 are illustrative and non-limiting. In general, band B may span any desired frequencies. Frequencies F0, F1, and F2 may be any desired frequencies. In practice, curves 140-146 may have other shapes.

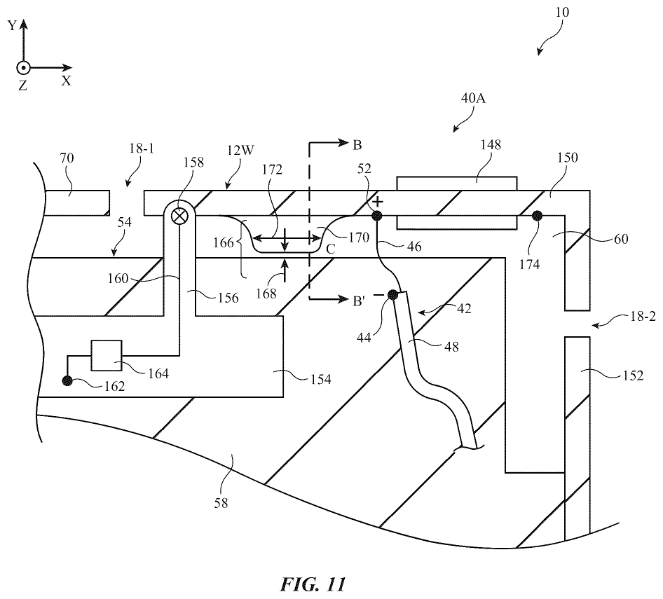

FIGS. 5-10 illustrate an example of an antenna 40 formed at the upper-left corner of device 10. FIG. 11 illustrates an antenna 40A that may be formed at the upper-right corner of device 10. Device 10 may include both antenna 40A of FIG. 11 and antenna 40 of FIGS. 5-10 (e.g., in the upper-right and upper-left corners of device 10 respectively). If desired, antenna 40A of FIG. 11 may be formed at the upper-left corner or a lower corner of device 10 and/or antenna 40 of FIGS. 5-10 may be formed at the upper-right corner or a lower corner of device 10. Alternatively, antenna 40A of FIG. 11 may be omitted from device 10 or antenna 40 of FIGS. 5-10 may be omitted from device 10. In the example of FIG. 11, display 14 have been omitted for the sake of clarity.

Antenna 40 of FIGS. 5-10 may convey radio-frequency signals in a first set of frequency bands. Antenna 40A of FIG. 11 may convey radio-frequency signals in a second set of frequency bands. The second set of frequency bands may be the same as the first set of frequency bands, the second set of frequency bands may include one or more but not all of the frequency bands from the first set of frequency bands (e.g., the second set of frequency bands may include one or more frequency bands not included in the first set of frequency bands), or the first set of frequency bands may be entirely different than the second set of frequency bands.

As shown in FIG. 11, peripheral conductive housing structures 12W may include a third conductive sidewall at the right edge of device 10. If desired, peripheral conductive housing structures 12W may include a first gap 18-1 that divides the second conductive sidewall (at the top end of device 10) to separate segment 70 of peripheral conductive housing structures 12W (or another segment of peripheral conductive housing structures 12W) from segment 150 of peripheral conductive housing structures 12W. If desired, peripheral conductive housing structures 12W may include a second gap 18-2 that divides the third conductive sidewall to separate segment 150 from segment 152 of peripheral conductive housing structures 12W. Segment 150 may, for example, include a bend or fold at the upper-right corner of device 10. If desired, gap 18-1 and/or gap 18-2 may be omitted from peripheral conductive housing structures 12W (e.g., gaps 18-1 and/or 18-2 may electrically define opposing edges of an antenna resonating element arm for antenna 40A and/or segments 70, 150, and/or 152 may be shorted to ground to electrically define one or more edges of the antenna resonating element arm for antenna 40A).

If desired, an electronic device component such as button 148 may be mounted to and/or may protrude through segment 150 of peripheral conductive housing structures 12W. Button 148 may be a power switch, a volume button, a slider, a rocker, an action button, a ringer switch, and/or any other desired user input device for device 10. Some of button 148 and/or some of the support components/circuitry for button 148 may overlap slot 60 and/or conductive support plate 58. Button 148 may protrude through segment 70 (FIG. 5) or may be omitted if desired.

The upper edge 54 of conductive support plate 58 may be separated from segment 150 by a portion of slot 60. Conductive support plate 58 may have a right edge that is coupled to segment 152 of peripheral conductive housing structures 12W. If desired, segment 152 and conductive support plate 58 may be formed from different integral portions of a single piece of metal (e.g., in a unibody configuration). Slot 60 may have an elongated shape that extends from the gap 18 in the first conductive sidewall (e.g., at the left edge of device 10 as shown in FIG. 5) to gap 18-2. Slot 60 may have an end at or defined by gap 18-2 or, if desired, a portion of slot 60 may extend downwards (e.g., in the −Y direction) below gap 18-2 between conductive support plate 58 and segment 152 of peripheral conductive housing structures 12W. Device 10 may include one or more components mounted to conductive support plate 58 in the vicinity of antenna 40A such as a speaker, an ambient light sensor module, a camera module, an infrared sensor module, a millimeter wave antenna module, an ultrawideband antenna module, a button module, a ringer module, a vibrator module, etc.

Device 10 may include a printed circuit board such as flexible printed circuit 154 overlapping slot 60 and/or conductive support plate 58. Flexible printed circuit 154 may be the same flexible printed circuit as flexible printed circuit 74 of FIG. 5 or may be a different flexible printed circuit in device 10. Flexible printed circuit 154 may have a tail (arm or branch) 156. Tail 156 may be coupled to a first point (location) on segment 150 of peripheral conductive housing structures 12W by conductive interconnect structure 158 (e.g., at or adjacent gap 18-1). Flexible printed circuit 154 may also be coupled to conductive support plate 58 and/or other ground structures by conductive interconnect structure 162. Conductive interconnect structure 162 may mechanically secure, attach, or otherwise affix flexible printed circuit 154 to conductive support plate 58. Conductive interconnect structure 158 may mechanically secure, attach, or otherwise affix flexible printed circuit 154 to segment 150. Tail 156 may extend over slot 60 from conductive support plate 58 to the end of segment 150 at or adjacent gap 18-1. If desired, tail 156 may be bent or folded around one or more parallel and/or non-parallel axes. Alternatively, flexible printed circuit 154 may be replaced with a rigid printed circuit board (e.g., without a fold).

Conductive interconnect structures 158 and 162 may include conductive pins, conductive springs (e.g., y-springs or spring fingers), conductive prongs (e.g., conductive blades that mate with conductive spring fingers such as y-springs), conductive brackets, conductive screws, conductive clips, conductive tape, conductive wires, conductive traces, conductive foam, conductive adhesive, solder, welds, metal members (e.g., sheet metal members), contact pads, conductive vias, and/or other conductive interconnect structures. Conductive interconnect structures 162 and 158 are sometimes also referred to herein simply as conductive interconnects.

Flexible printed circuit 154 may include a conductive trace 160 that extends from conductive interconnect structure 158, through tail 156, to conductive interconnect structure 162. Conductive interconnect structure 158 may electrically couple (e.g., short) a point on segment 150 to ground (e.g., conductive interconnect structure 162) through conductive trace 160 and conductive interconnect structure 162. Put differently, conductive interconnect structures 158 and 162 and conductive trace 160 may form an electrical return path from segment 150 to ground.

Antenna 40A may be integrated into conductive support plate 58 and segment 150 of peripheral conductive housing structures 12W for conveying radio-frequency signals through the front and/or rear faces of device 10. Antenna 40A may have an antenna resonating element (e.g., antenna resonating element 45 of FIG. 3) that includes an antenna arm formed from segment 150. Antenna 40A may be fed by a corresponding transmission line path 42. A ground conductor 48 of transmission line path 42 may be coupled to ground (e.g., conductive support plate 58) at ground antenna feed terminal 44. A signal conductor 46 of transmission line path 48 may be coupled to a positive antenna feed terminal 52 on segment 150 (e.g., across slot 60 from the ground antenna feed terminal).

Conductive interconnect structure 158 may be interposed on segment 150 between positive antenna feed terminal 52 and gap 18-1. Positive antenna feed terminal 52 may be interposed on segment 150 between conductive interconnect structure 158 and gap 18-2. If desired, positive antenna feed terminal 52 may be interposed on segment 150 between button 148 and conductive interconnect structure 158. Alternatively, button 148 may be interposed on segment 150 between positive antenna feed terminal 52 and conductive interconnect structure 158 (e.g., positive antenna feed terminal 52 may be coupled to segment 150 at point 174). As one example, the transmission line path 42 for antenna 40A may include a coaxial cable and, in some implementations, may also include a feed printed circuit board that couples the coaxial cable to segment 150.

When antenna 40A conveys radio-frequency signals, corresponding antenna current flows along segment 150 (e.g., between gaps 18-1 and 18-2) and along edge 54 of conductive support plate 58. Some of the antenna current may flow between segment 150 and ground via conductive interconnect structure 158, conductive trace 160, and conductive interconnect structure 162 (e.g., segment 150 may form an inverted-F antenna resonating element arm that has a return path formed from conductive trace 160 and conductive interconnect structures 158 and 160).

Given the presence of other components in device 10 such as button 148, speaker 82 (FIG. 5), and other components around antenna 40A, the resonating characteristic of segment 150 may not be sufficient on its own for antenna 40 to cover all frequencies within a given frequency range of interest such as a frequency range that includes a first band around 1700-2200 MHZ (e.g., one or more cellular midbands) and a second band around 2300-2700 MHZ (e.g., one or more cellular high bands). To extend the frequencies covered by antenna 40A (e.g., with greater than a threshold antenna efficiency), antenna 40A may include one or more antenna tuning components.

For example, antenna 40A may include tuning circuitry 164 disposed on conductive trace 160 of flexible printed circuit 154. Tuning circuitry 164 may include one or more aperture tuners and/or impedance matching circuits for antenna 40A. If desired, tuning circuitry 164 may include SMT components on flexible printed circuit 154 such as SMT capacitors, resistors, inductors, switches, etc. Tuning circuitry 164 may be adjusted to tune the frequency response of antenna 40A. If desired, tuning circuitry 164 may have at least a first state in which an open circuit (infinite) impedance is disposed on conductive trace 160 (e.g., configuring segment 150 to form an inverted-F antenna resonating element arm) and a second state in which a short circuit (zero) impedance is disposed on conductive trace 160 (e.g., forming a short circuit return path between segment 150 and ground). If desired, tuning circuitry 164 may have one or more states in which different non-zero and non-infinite impedances are disposed on conductive trace 160. If desired, flexible printed circuit 154, conductive interconnect structure 158, and/or conductive trace 160 may be omitted (e.g., segment 150 need not be coupled to ground at the location of conductive interconnect structure 158).

It may also be desirable for antenna 40A to include tuning circuitry coupled to segment 150 at a location between conductive interconnect structure 158 and positive antenna feed terminal 52 (e.g., to perform further aperture tuning for antenna 40A that serves to expand the effective bandwidth of antenna 40A). In some implementations, a flexible printed circuit tail is coupled to segment 150 between positive antenna feed terminal 52 and conductive interconnect structure 158, where the flexible printed circuit tail includes one or more SMT components (e.g., capacitors, resistors, inductors, switches, etc.) coupled in series and/or in parallel between segment 150 and ground (e.g., conductive support plate 58). However, there may be insufficient room for a flexible printed circuit tail at this location (e.g., due to the presence of other device structures such as a speaker, button 148, etc.). In addition, the dielectric material of the flexible printed circuit tail can produce signal loss for antenna 40A, which can limit the overall antenna efficiency of antenna 40A across a desired frequency range.

To mitigate these issues, antenna 40A may include a distributed capacitance 166 formed from conductive support plate 58 and a portion of segment 150 between positive antenna feed terminal 52 and conductive interconnect structure 158. Distributed capacitance 166 may, for example, be coupled in series between the antenna resonating element arm for antenna 40A (e.g., segment 150) and the ground for antenna 40A (e.g., conductive support plate 58).

For example, as shown in FIG. 11, peripheral conductive housing structures 12W may include a conductive protrusion such as protrusion 170. Protrusion 170 protrudes away from segment 150 and into slot 60 towards edge 54 of conductive support plate 58. Protrusion 170 may, for example, be formed from an integral lip, ledge, extension, prong, tab, or finger of segment 150. Alternatively, protrusion 170 may be formed from a separate piece of conductive material than segment 150 (e.g., protrusion 170 may be mechanically and electrically attached to segment 150 using welds, solder, conductive adhesive, and/or other conductive interconnect structures). The edge of protrusion 170 may be separated from edge 54 of conductive support plate 58 by gap 168. Gap 168 is free of conductive material and serves to establish distributed capacitance 166 between segment 150 and conductive support plate 58. In this way, protrusion 170 and conductive support plate 58 may form opposing capacitor plates or electrodes of distributed capacitance 166.

Distributed capacitance 166 may have a magnitude C. Distributed capacitance 166 is sometimes also referred to herein as a distributed capacitor 166 having a capacitance of magnitude C. The magnitude C of distributed capacitance 166 may be determined by the width of gap 168 (e.g., where greater widths decrease magnitude C and lower widths increase magnitude C) and the width 172 of protrusion 170 (e.g., where greater widths 172 increase magnitude C and lower widths 172 decrease magnitude C). The magnitude C of distributed capacitance 166 may be selected to boost the antenna efficiency of antenna 40A in one or more frequency bands. Gap 168 may have a width of 0.1-0.5 mm, 0.2-0.4 mm, 0.25-0.35 mm, less than 1 mm, greater than 0.1 mm, or other widths, as examples. Integrating distributed capacitance 166 into peripheral conductive housing structures 12W and conductive support plate 58 in this way may allow antenna 40A to achieve a desired frequency response without use of additional tuning components (e.g., SMT components), circuits, or flexible printed circuits between positive antenna feed terminal 52 and conductive interconnect structure 158. This may, for example, provide additional space for other components of device 10, may help to reduce the size of device 10 without sacrificing antenna performance, and/or may help to minimize signal loss at antenna 40A.

The example of FIG. 11 is illustrative and non-limiting. If desired, distributed capacitance 166 may be interposed between positive antenna feed terminal 52 and gap 18-2 and/or between button 148 and gap 18-2. If desired, antenna 40A may include multiple distributed capacitances 166 at different locations along segment 150.

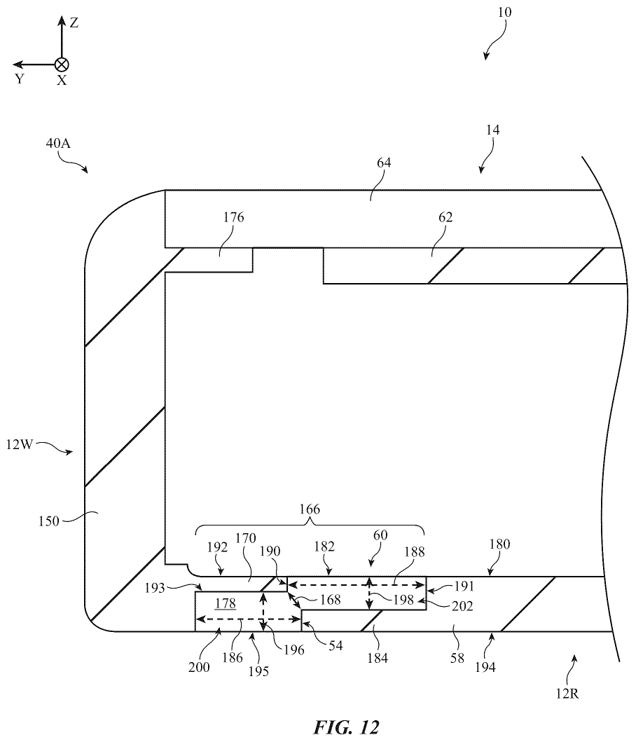

FIG. 12 is a cross-sectional side view of antenna 40A (e.g., as viewed along line BB′ of FIG. 11). As shown in FIG. 12, peripheral conductive housing structures 12W may include a ledge 176 protruding into the interior of device 10 from segment 150 at the front face of device 10. Display 14 may be mounted to ledge 176. Protrusion 170 may protrude away from segment 150 towards the interior of device 10 at the rear face of device 10. Dielectric cover layer 56 (FIG. 4) is not illustrated in FIG. 12 for the sake of clarity and may be omitted from rear housing wall 12R or may, if desired, be layered under conductive support plate 58 in rear housing wall 12R.

Conductive support plate 58 may have a first lateral surface such as interior surface 180 and may have an opposing second lateral surface such as exterior surface 194. Protrusion 170 may extend away from segment 150 and into slot 60 towards conductive support plate 58. Protrusion 170 may have an end opposite segment 150 such as edge 190. Protrusion 170 may also have a first lateral surface 192 (e.g., facing the interior of device 10) and an opposing second lateral surface 193. Lateral surfaces 192 and 193 may extend from segment 150 to edge 190. If desired, conductive support plate 58 may also have a conductive protrusion such as protrusion 184 that extends beyond an edge 191 of conductive support plate 58, into slot 60, and towards segment 150. The end of protrusion 184 may form edge 54 of conductive support plate 58.

Slot 60 may be filled with dielectric material 178 (e.g., plastic such as injection molded plastic, glass, polymer, resin, ceramic, etc.). Slot 60 and the dielectric material 178 in slot 60 may vertically extend through rear housing wall 12R from a first lateral surface 182 (e.g., at the interior of device 10) to an opposing second lateral surface 195. If desired, lateral surface 182 of dielectric material 178 may lie flush with (e.g., may be coplanar with) interior surface 180 of conductive support plate 58 and/or lateral surface 192 of protrusion 170. If desired, lateral surface 195 of dielectric material 178 may lie flush with (e.g., may be coplanar with) exterior surface 194 of conductive support plate 58.

If desired, slot 60 may include a first portion 200 and a second portion 202 that at least partially overlaps portion 200. Portion 200 may extend from segment 150 to edge 54 of protrusion 184. Portion 200 may have a width 186 (e.g., parallel to the Y-axis) from segment 150 to edge 54 and may have a depth 196 (e.g., parallel to the Z-axis) from lateral surface 195 of dielectric material 178 to lateral surface 193 of protrusion 170. Portion 202 may extend from edge 190 of protrusion 170 to edge 191 of conductive support plate 58. Protrusions 170 and 184 may, if desired, be embedded within dielectric material 178.

Portion 202 may have a width 188 (e.g., parallel to the Y-axis) from edge 190 to edge 191 and may have a depth 198 (e.g., parallel to the Z-axis) from lateral surface 182 to protrusion 184. Portion 200 may be formed, for example, by performing a first machining, milling, or drilling operation on a piece of conductive material forming segment 150 and conductive support plate 58 in a first direction, from exterior surface 194 and towards the interior of device 10. Portion 202 may be formed, for example, by performing a second machining, milling, or drilling operation on the piece of conductive material in a second direction, from lateral surface 180 and towards the exterior of device 10. Dielectric material 178 may fill portions 202 and 200 and may couple portion 202 to portion 200. Edge 190 of protrusion 170 may be separated from edge 54 of protrusion 184 by gap 168. Protrusion 170, protrusion 184, and gap 168 may collectively form distributed capacitance 166 for antenna 40A. The example of FIG. 12 is illustrative and non-limiting. If desired, slot 60, protrusion 170, and/or protrusion 184 may have other shapes.

If care is not taken, the presence of protrusion 170 within slot 60 may produce divots, bumps, or other cosmetic defects at lateral surface 195 and/or lateral surface 182 of the dielectric material 178 in slot 60 (e.g., produced by a buildup of dielectric material 178 that flows around protrusion 170 upon deposition). To mitigate these issues, one or more slots may be formed in protrusion 170 to draw in some of the dielectric material 178 in slot 60, helping to prevent divots, bumps, or other cosmetic defects at lateral surface 195 and/or lateral surface 182.

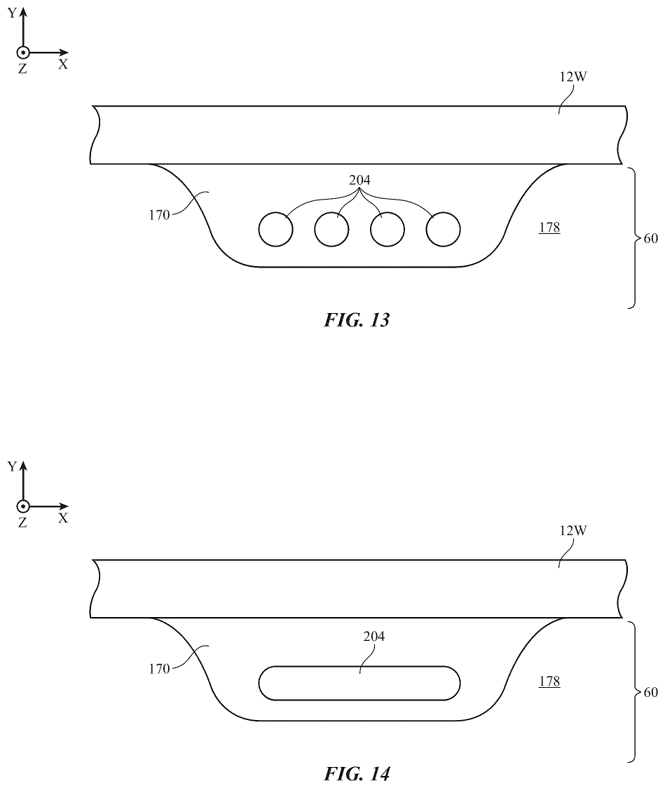

FIG. 13 is an interior top view showing a first example of how one or more slots may be formed in protrusion 170. In the example of FIG. 13, protrusion 170 includes a set of slots 204 (e.g., holes extending through protrusion 170 from lateral surface 193 to lateral surface 192 of FIG. 2). When dielectric material 178 is deposited in slot 60, some of the dielectric material may be drawn into holes 204. This may help to prevent the formation of bumps, divots, or other cosmetic defects at the lateral surfaces of dielectric material 178.

Protrusion 170 may include a single slot 204, two slots 204, three slots 204, four slots 204 (as shown in FIG. 13), or more than four slots 204. If desired, slots 204 may extend through some but not all of protrusion 170 (e.g., from lateral surface 193 or from lateral surface 192 of FIG. 12). In the example of FIG. 13, slots 204 are circular. This is illustrative and, in general, slots 204 may have any desired shapes (e.g., an elongated shape, an elliptical shape, a rectangular shape, a polygonal shape, a rounded shape, etc.). Slots 204 are sometimes also referred to herein as openings, notches, or holes in protrusion 170.

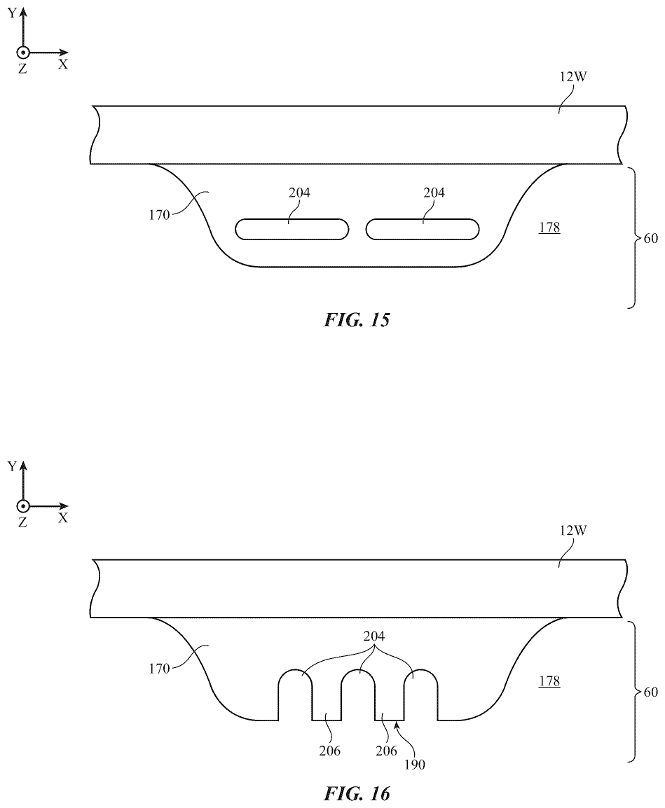

FIG. 14 shows another example in which protrusion 170 is provided with a single elongated slot 204 (e.g., an elongated slot that extends along a longitudinal axis parallel to the peripheral conductive housing structures 12W and the X-axis). If desired, the elongated slot may have rounded ends. FIG. 15 shows another example in which protrusion 170 includes two elongated slots 204 (e.g., arranged in a colinear pattern). The two elongated slots 204 in FIG. 15 need not be colinear. In practice, larger slots 204 will draw in more dielectric material 178 than smaller slots 204.

In the examples of FIGS. 13-15, slots 204 are closed slots that are completely surrounded on all sides (e.g., in the X-Y plane) by conductive material in protrusion 170. The closed slots may produce minimal impact on the resonating characteristics of antenna 40A. This is illustrative and non-limiting. If desired, one or more of the slots 204 in protrusion 170 may be open slots. FIG. 16 shows an example in which protrusion 170 includes a set of open slots 204.

As shown in FIG. 16, slots 204 may be surrounded on some but not all sides by conductive material in protrusion 170 and may each have at least one side (edge) defined by the dielectric material 178 in slot 60. The open slots may be laterally separated from each other by prongs (fingers) 206 of conductive material in protrusion 170. If desired, one or more prongs 206 may be bent or folded to help engage and secure dielectric material 178 to protrusion 170. In practice, the open slots may also serve to adjust the resonating length of antenna 40A and may, if desired, be configured to adjust or tune the frequencies covered by antenna 40A (e.g., boosting the antenna efficiency of antenna 40A at relatively high frequencies relative to implementations where protrusion 170 does not include open slots). If desired, protrusion 170 may include a combination of two or more of the types of slots 204 shown in FIGS. 13-16. Slots 204 may have any desired shape and may have any desired number of straight and/or rounded edges.

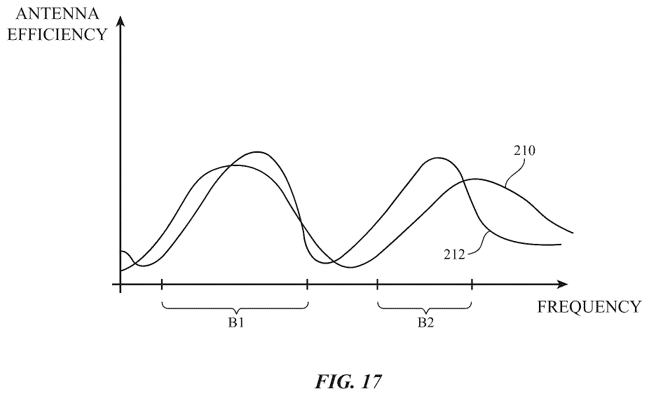

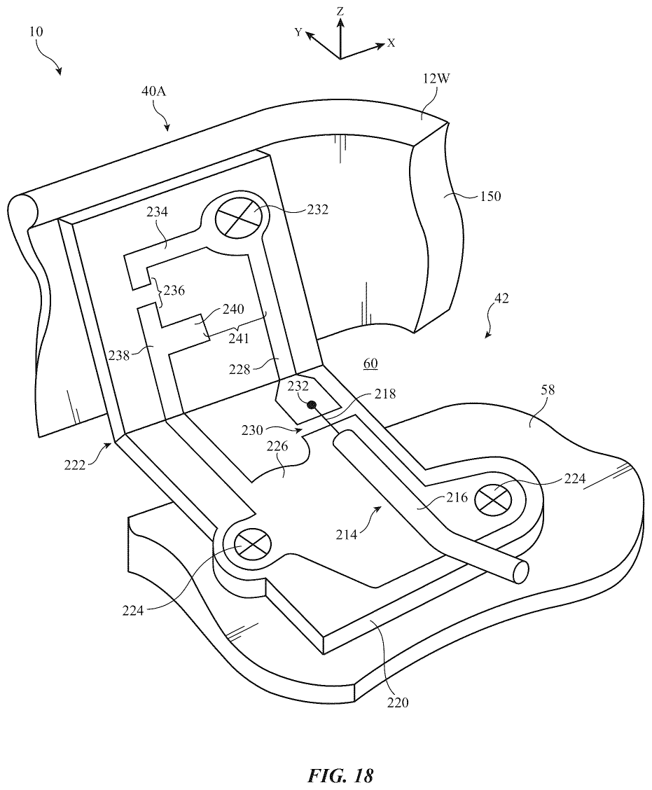

FIG. 17 is a plot of antenna efficiency as a function of frequency for antenna 40A. Curve 210 represents the response of antenna 40A in the absence of distributed capacitance 166. Curve 212 illustrates the response of antenna 40A when provided with distributed capacitance 166. As shown by curve 210, antenna 40A may exhibit response peaks overlapping at least a first frequency band B1 (e.g., around 1700-2200 MHZ) and a second frequency band B2 (e.g., around 2300-2700 MHZ). As shown by curve 212, distributed capacitance 166 may serve to boost the antenna efficiency of antenna 40A at relatively high frequencies within frequency band B1 and/or at relatively low frequencies within frequency band B2. The example of FIG. 17 is illustrative and non-limiting. In practice, curves 210 and 212 may have other shapes and may overlap any desired frequency bands.

If desired, the transmission line path 42 for antenna 40A (FIG. 5) may include a coaxial cable and a flexible printed circuit that couples the coaxial cable to segment 150 of peripheral conductive housing structures 12W. FIG. 18 is an interior front view showing one example of how the transmission line path 42 for antenna 40A may include a coaxial cable and a flexible printed circuit that couples the coaxial cable to segment 150 of peripheral conductive housing structures 12W.

As shown in FIG. 18, transmission line path 42 may include a flexible printed circuit 220 overlapping conductive support plate 58 and extending across slot 60 to segment 150 of peripheral conductive housing structures 12W. Conductive interconnect structure 232 may mechanically and electrically couple a conductive trace 228 on flexible printed circuit 220 to segment 150 at the positive antenna feed terminal 52 for antenna 40A (e.g., to the left of button 148 as shown in FIG. 11 or to the right of button 148 such as at point 174 of FIG. 11).

If desired, flexible printed circuit 220 may include a fold or bend such as fold 222 (e.g., about an axis parallel to the X-axis). Conductive trace 228 may extend down flexible printed circuit 220 and across fold 222. Conductive trace 228 may be separated from a conductive trace 226 on flexible printed circuit 220 by gap 230. Conductive trace 226 may be held at a ground potential and may therefore sometimes be referred to herein as ground trace 226. For example, one or more conductive interconnect structures 224 may electrically and mechanically couple conductive trace 226 to conductive support plate 58.

Transmission line path 42 may also include a coaxial cable such as coaxial cable 214. Coaxial cable 214 includes a ground conductor 216 that is shorted to ground via conductive trace 226 (e.g., at ground antenna feed terminal 44 of FIG. 11). Coaxial cable 214 also includes a signal conductor 218 that extends across gap 230 and that is coupled to conductive trace 228 at point 232 (e.g., using solder). Conductive trace 228 and signal conductor 218 may collectively form the signal conductor 46 (FIG. 3) for transmission line path 42. Conductive trace 228 may sometimes also be referred to herein as signal trace 228.

Flexible printed circuit 220 may also include a conductive trace 234 extending away from conductive trace 228 and conductive interconnect structure 232. Conductive trace 234 may be separated from an additional conductive trace 238 on flexible printed circuit 220 by a gap. Conductive trace 238 may extend down flexible printed circuit 220 and across fold 222 to conductive trace 226. The gap between conductive traces 234 and 238 may form a distributed capacitance 236 coupled in series between the signal conductor of transmission line path 42 and ground (conductive trace 226). The width and/or length of the gap between conductive traces 234 and 238 may be selected to provide distributed capacitance 236 with a desired magnitude.

If desired, flexible printed circuit 220 may also include a conductive stub 240 extending from a side of conductive trace 238. Stub 240 may be separated from conductive trace 228 by a gap forming an additional distributed capacitance 241 coupled in series between the signal conductor of transmission line path 42 and ground (conductive trace 226). The width of the gap and/or the width of stub 240 may be selected to provide distributed capacitance 241 with a desired magnitude. If desired, stub 240 and/or conductive trace 238 may also form a distributed capacitance with segment 150 of peripheral conductive housing structures 12W for tuning the frequency response and/or impedance matching of antenna 40A.

Distributed capacitance 236 and distributed capacitance 241 may collectively form a distributed shunt capacitance or shunt capacitor between the signal conductor of transmission line path 42 and ground (conductive trace 226). This shunt capacitance may serve to tune the frequency response of antenna 40A and/or to perform impedance matching for antenna 40A without the use of bulky SMT components on flexible printed circuit 220. If desired, the transmission line path 42 of FIG. 18 may be used to feed antenna 40 of FIGS. 5-8. Conductive traces 234, 228, 226, and 238 may have other shapes. Additional distributed shunt capacitances may be provided on flexible printed circuit 220 if desired.

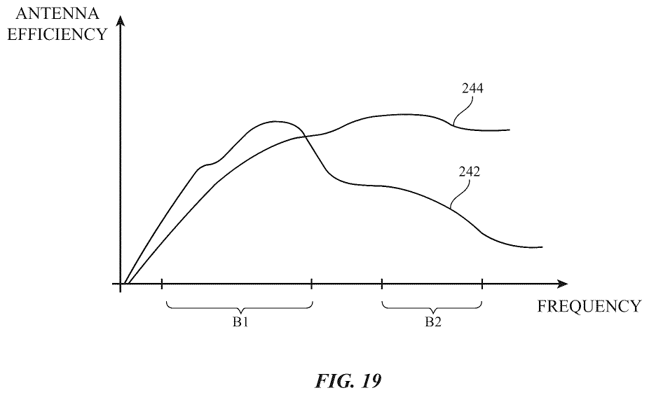

FIG. 19 is a plot of antenna efficiency as a function of frequency for antenna 40A. Curve 242 represents the response of antenna 40A in the absence of a shunt capacitance between the signal conductor of transmission line path 42 and ground. Curve 244 plots the response of antenna 40A when provided with distributed capacitances 236 and 241 of FIG. 18. As shown by curves 242 and 244, distributed capacitances 236 and 241 of FIG. 18 may serve to boost the response of antenna 40A in at least one band such as frequency band B2. The example of FIG. 18 is illustrative and non-limiting. In practice, curves 242 and 244 may have other shapes and may overlap any desired frequency bands.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users. The foregoing is illustrative and various modifications can be made by those skilled in the art without departing from the scope and spirit of the described embodiments. The foregoing embodiments may be implemented individually or in any combination.

What is claimed is:

1. An electronic device comprising:
peripheral conductive housing structures having a segment with a bend at a corner of the electronic device;
a display mounted to the peripheral conductive housing structures;
a conductive housing wall opposite the display;
a slot that separates the conductive housing wall from the segment; and
an antenna that includes a positive antenna feed terminal coupled to the segment and that includes a parasitic arm having a first end and an opposing second end, wherein
the first end is separated from the segment by a gap,
the second end is electrically shorted to the conductive housing wall, and
the segment is configured to indirectly feed the parasitic arm via a capacitive coupling across the gap.

2. The electronic device of claim 1, wherein the segment is configured to indirectly feed the parasitic arm at a first location on the segment and the antenna further comprises:
a conductive trace that couples a second location on the segment to the conductive housing wall across the slot.

3. The electronic device of claim 2, wherein the positive antenna feed terminal is interposed on the segment between the first location and the second location.

4. The electronic device of claim 3, further comprising:
a conductive spring that couples a third location on the segment to the display, wherein the first location is interposed on the segment between the positive antenna feed terminal and the third location.

5. The electronic device of claim 1, wherein the gap overlaps the slot.

6. The electronic device of claim 1, further comprising:
a flexible printed circuit, wherein the parasitic arm comprises a conductive trace on the flexible printed circuit; and
a contact pad on the flexible printed circuit, the gap having opposing edges defined by the contact pad and the conductive trace.

7. The electronic device of claim 6, further comprising:
a conductive screw that attaches the flexible printed circuit to the segment and that electrically couples the contact pad to the segment.

8. The electronic device of claim 7, further comprising:
an additional conductive screw that electrically couples the second end of the parasitic arm to the conductive housing wall.

9. The electronic device of claim 8, wherein the contact pad, the conductive trace, and the gap form a distributed capacitance that is coupled in series between the contact pad and the additional conductive screw.

10. The electronic device of claim 8, wherein the flexible printed circuit has a first tail and a second tail, the conductive screw attaches the first tail to a first location on the segment, the contact pad is on the first tail, and the electronic device further comprises:
an additional conductive trace on the second tail, wherein the additional conductive trace couples a second location on the segment to the conductive housing wall, the positive antenna feed terminal being interposed on the segment between the first location and the second location.

11. The electronic device of claim 10, further comprising tuning circuitry disposed on the additional conductive trace and surface-mounted to the flexible printed circuit.

12. The electronic device of claim 1, wherein the parasitic arm comprises a folded sheet metal member that extends from the first end to the second end, the electronic device further comprising a conductive screw that couples the second end to the conductive housing wall.

13. The electronic device of claim 1, further comprising:
a speaker, wherein the parasitic arm overlaps the speaker.

14. The electronic device of claim 13, further comprising:
a shim on the speaker, wherein the parasitic arm is mounted to the shim.

15. The electronic device of claim 1, wherein the peripheral conductive housing structures include an additional segment separated from the segment by a first additional gap, the electronic device further comprising:
an additional antenna that includes an additional positive antenna feed terminal coupled to the additional segment;
a first flexible printed circuit that couples a point on the additional segment to the conductive housing wall;
a first distributed capacitance configured to tune a frequency response of the additional antenna, wherein the first distributed capacitance is formed between an edge of the conductive housing wall and a protrusion on the additional segment, the protrusion protrudes away from the additional segment and into the slot, and the protrusion is between the point on the additional segment and the additional positive antenna feed terminal;
a dielectric material in the slot, wherein a first portion of the dielectric material extends from an exterior surface of the slot to the protrusion, a second portion of the dielectric material extends from an interior surface of the conductive wall, and the second portion of the dielectric material at least partially overlaps the first portion of the conductive wall;
at least one opening in the protrusion that receives at least some of the dielectric material;
a second flexible printed circuit coupled to the positive antenna feed terminal;
first, second, third, and fourth conductive traces on the second flexible printed circuit, wherein the first and second conductive traces are separated by a second additional gap, the second and third conductive traces are coupled to the additional positive antenna feed terminal, the third conductive trace extends away from the second conductive trace, the third conductive trace is separated from the fourth conductive trace by a second distributed capacitance, the fourth conductive trace extends from the second distributed capacitance to the first conductive trace, and the first conductive trace is coupled to the conductive plate;
a stub coupled to the fourth conductive trace, the stub being separated from the second conductive trace by a third distributed capacitance; and
a coaxial cable having a ground conductor coupled to the first conductive trace and having a signal conductor coupled to the second conductive trace across the second additional gap.

16. An electronic device comprising:
a housing having peripheral conductive housing structures and a conductive wall;
a slot that separates the conductive wall from a segment of the peripheral conductive housing structures and that is filled with a dielectric material;
a display mounted to the peripheral conductive housing structures opposite the conductive wall;
a conductive protrusion on the segment, extending into the slot towards an edge of the conductive wall, and embedded in the dielectric material;
an antenna having a resonating element arm that includes the segment and having an antenna ground that includes the conductive wall; and
a distributed capacitor coupled in series between the resonating element arm and the antenna ground and configured to tune a frequency response of the antenna, wherein the distributed capacitor has a first electrode that includes the conductive protrusion and has a second electrode that includes the edge of the conductive wall.

17. The electronic device of claim 16, further comprising at least one hole in the conductive protrusion and configured to receive at least some of the dielectric material, the at least one hole comprising: a circular hole, an elongated hole, or a plurality of open-ended slots.

18. The electronic device of claim 16, further comprising:
a flexible printed circuit;
first, second, third, and fourth traces on the flexible printed circuit;
a first conductive interconnect that couples the second and third traces to the segment at a positive antenna feed terminal of the antenna, wherein the third trace extends away from the second trace;
a second conductive interconnect that couples the first trace to the conductive wall;
an additional distributed capacitor having a third electrode that includes the third trace and having a fourth electrode that includes the first trace; and
a coaxial cable having a ground conductor coupled to the first trace and having a signal conductor coupled to the second trace.

19. An electronic device comprising:
peripheral conductive housing structures;
a display mounted to the peripheral conductive housing structures;
a rear housing wall mounted to the peripheral conductive housing structures opposite the display, the rear housing wall having a conductive support plate;
a positive antenna feed terminal coupled to the peripheral conductive housing structures;
a folded sheet metal member having a first end that is electrically shorted to the conductive support plate and having a second end opposite the first end; and
a gap between the second end of the folded sheet metal member and the peripheral conductive housing structures, wherein the peripheral conductive housing structures are configured to indirectly feed the folded sheet metal member via a capacitive coupling across the gap.

20. The electronic device of claim 19, further comprising:
a first conductive screw coupled to the segment;
a second conductive screw that couples the first end of the folded sheet metal member to the conductive support plate, wherein the second end of the folded sheet metal member overlaps a portion of the peripheral conductive housing structures, the positive antenna feed terminal being interposed on the peripheral conductive housing structures between the first conductive screw and the portion of the peripheral conductive housing structures;
a conductive trace that couples the first conductive screw to the conductive support plate; and
a conductive spring that couples the peripheral conductive housing structures to the display, the portion of the peripheral conductive housing structures being interposed on the peripheral conductive housing structures between the positive antenna feed terminal and the conductive spring.
